(19) United States
(12) Patent Application Publication
(10) Pub. No.: US 2002/0008678 A1
(43) Pub. Date: Jan. 24, 2002

(54) Block driver circuit for plasma display panel

(76) Inventor: James C. Rutherford, Fort Wayne, IN (US)

Correspondence Address: George Pappas, PAPPAS LAW OFFICE, Suite 300, 919 S. Harrison Street, Fort Wayne, IN, 46802, US

(21) Appl. No.: 09/907,972

(22) Filed: Jul. 18, 2001

Related U.S. Application Data
(60) Provisional application No. 60/219,729, filed on Jul. 19, 2000.

(51) Int. Cl. G09G 3/28

(52) U.S. Cl. 345/60

(57) ABSTRACT

The present invention relates to a plasma display panel having two or more drive blocks, each independently driving a segment of the plasma display screen. Additional circuitry is provided, whose output is integrated into the control of time period for sustain pulses of each drive block. The number of sustain pulses of each drive block is adjusted depending on the number of on cells in that drive block. Being able to adjust the number of sustain pulses produced by each drive block to the variation in luminous that would be caused by probable different loading by the display screen segments results in luminous uniformity across the entire plasma display screen. Circuitry in each block is provided for the independent odd/even row sustain pulses and the common odd/even row setup pulses.

Applicant hereby claims priority of provisional U.S. Application No. 60/219,729 filed Jul. 19, 2000.

### FIELD OF THE INVENTION

The present invention relates to a plasma display panel having two or more drive blocks, each independently driving a segment of the plasma display screen. Additional circuitry is provided, whose output is integrated into the control of time period for sustain pulses of each drive block. Being able to adjust the number of sustain pulses produced by each drive block to the variation in luminous that would be caused by probable different loading by the display screen segments results in luminous uniformity across the entire plasma display screen. Circuitry in each block is provided for the independent odd/even row sustain pulses and the common odd/even row setup pulses.

### DISCUSSION OF THE RELATED ART

The circuit arrangement shown in FIG. 1 has multiple drive blocks that are connected to the plasma display screen. Each block independently performs the setup, addressing and sustaining of a segment of the plasma display screen. Because the sustaining pulse generating circuits are provided independently in association with the drive block, then the display screen segment associated with each drive block emit light with different luminances. Reasons why such luminance differences are produced by the drive blocks will be described below.

FIG. 2 of the accompanying drawings shows a basic sustaining pulse generating circuit for use as the clamp circuit of the sustaining pulse generator circuit. If the N-channel FETs have an on-state resistance of about 0.5 ohms with respect to a peak current of about 20 A, thus producing a voltage drop of about 10 V. If economy were ignored, then it would be possible to use a switching device such as a FET having a larger current capacity and a smaller on-state current. However, in view of cost and size considerations, it is necessary to use FETs of such an on-state resistance.

As described above, a voltage drop in circuits for generating sustaining pulses when discharge light emissions are produced is mainly developed by switches such as FETS.

FIG. 3a of the accompanying drawings shows the waveforms of voltages in the sustaining pulse generating circuit shown in FIG. 2 where the number of light-emitting pixels is small, and FIG. 3b of the accompanying drawings shows the waveforms of voltages in the sustaining pulse generating circuit shown in FIG. 2 where the number of light-emitting pixels is large. In FIGS. 3a and 3b, the reference numerals “60” represents a sustaining pulse and the reference numerals “61”˜“64”, voltage reductions at the time of a discharge light emission.

When the number of light-emitting pixels is small, as shown in FIG. 3a, the voltage drop across the N-channel FET is small, and the voltage reduction caused at the voltage measuring point PP2 by a voltage drop due to the discharge light emission is also small. However, when the number of light-emitting pixels is large, as shown in FIG. 3b, while any potential fluctuations at the voltage measuring point PP1 are small, the voltage drop across the N-channel FET is large, and the voltage reduction due to a discharge light emission is of a large value of at least 10 V.

Therefore, the luminance of light emissions from the drive blocks where the number of light-emitting pixels is small is high because the voltage reduction is small and a sufficient voltage is applied to the light-emitting pixels, whereas the luminance of light emissions from drive blocks where the number of light-emitting pixels is large is low because the voltage reduction is large and sufficient voltage is not applied to the light-emitting pixels.

Such a phenomenon may be minimized by reducing the internal resistance of the circuits for generating sustaining pulses to a sufficiently low level. Specifically, the internal resistance of switching elements such as power FETs that develop a large voltage drop in the circuits for generating sustaining pulses may be reduced to a sufficiently low level. If the internal resistance of such switching elements is reduced to a sufficiently low level, however, the switching elements have to be greatly increased in size. As a result, not only the sustaining pulse generating circuits are greatly increased in cost to the point where these switching elements and circuits are not practically affordable. According to the conventional technical achievements limited by physical sizes and economical limitations, therefore, the drive blocks which have different numbers of light-emitting pixels have suffered different levels of luminance.

If the drive blocks for different plasma display segments produce different levels of luminance, then luminance differences can clearly be perceived between the plasma display segments. Such luminance differences can immediately be recognized by not only by persons who are deeply involved in image display fields but also general people who watch display devices. The luminance differences between the drive blocks are not contained in original images to be displayed, and hence make display images false. The luminance differences are conspicuous particularly in the display of scenic images, and tend to completely impair the displayed quality of scenic images. Such a shortcoming is fatal for display units, and so crucial that it will spoil the commercial value of display units.

### SUMMARY OF THE INVENTION

The present invention provides a circuit whose output is integrated into the panel drive control unit. This is for the purpose of controlling the number of sustain pulses needed to compensate for major variations in display screen segment loading to the drive block circuit.

Diodes are connected in each drive block keeping the sustain pulses generated in the odd and even sustaining circuits from going around to the other. Other diodes are connected to enable common switch drive for the setup waveforms in a drive block.

In one form thereof the present invention is directed to a method of driving a plasma display panel having a plurality of independently driven display drive blocks of cells wherein each image is displayed on the panel by addressing on desired cells in each drive block and sustaining the on cells with a desired number of sustain pulses. The method includes the steps of determining the number of on cells of each display drive block and adjusting the desired number of sustain pulses of each display drive block. The adjustment of the desired number of sustain pulses of each drive block is determined by the number of on cells in the drive block, thereby providing an adjustment to the total number of sustain pulses to compensate for the different loading of the drive block electronics. In this manner luminance uniformity is maintained between the drive blocks across the entire plasma display panel Preferably the number of on cells for each drive block is determined during the addressing period of that drive block. Also, an adjustment or look up table is used for establishing the sustain pulse adjustment for each drive block. Yet more preferably, the number of sustain pulses are increased as the number of on cells increases for thereby compensating for the different loading of the drive block electronics.

### BRIEF DESCRIPTION OF THE DRAWINGS

The above mentioned and other features and objects of this invention and the manner of obtaining them will become more apparent and the invention itself will be better understood by reference to the following description of embodiments of the invention taken in conjunction with the accompanying drawings wherein:

FIG. 1 is a prior art diagram illustrating the drive blocks structure of a plasma display;

FIG. 2 is a prior art circuit diagram of a basic sustaining pulse generating circuit for the scanning electrode blocks or the sustaining electrode blocks.

FIG. 3A is prior art diagram showing the waveforms of voltages in the basic sustaining pulse generating circuit for the scanning electrode blocks or the sustaining electrode blocks where the number of light-emitting pixels is small;

FIG. 3B is prior art diagram showing the waveforms of voltages in the basic sustaining pulse generating circuit for the scanning electrode blocks or the sustaining electrode blocks where the number of light-emitting pixels is large;

FIG. 4 is a drive circuit that illustrates one of the embodiments of the present invention;

FIG. 5 is a table of a 1080 row plasma display panel that has five drive blocks and twelve sub-frames.

FIG. 6 illustrates the waveforms in each of the blocks of FIG. 5.

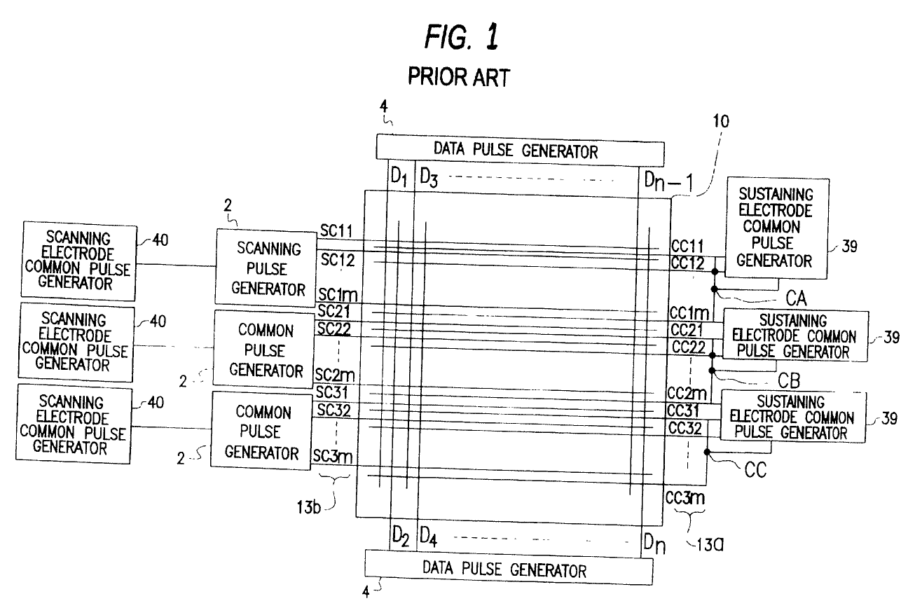

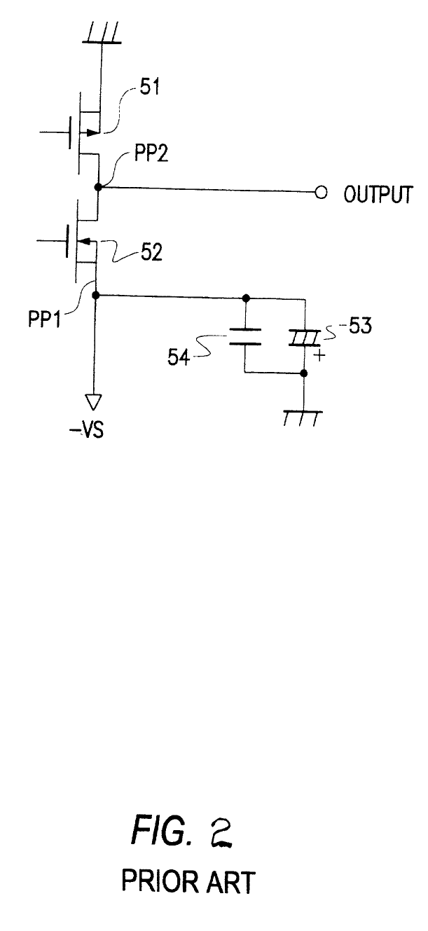

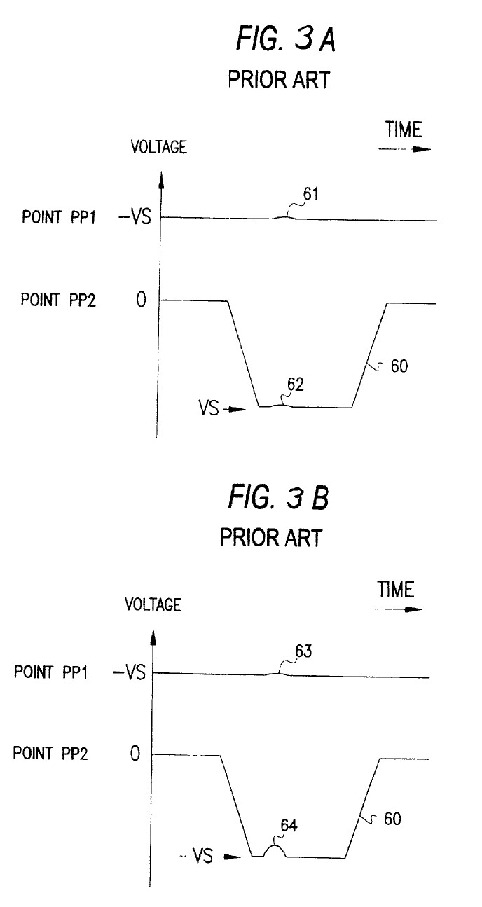

Corresponding reference characters indicate corresponding parts throughout the several views of the drawings.

The exemplifications set out herein illustrate preferred embodiments of the invention in one form thereof and such exemplifications are not to be construed as limiting the scope of the disclosure or the scope of the invention in any manner.

### DETAILED DESCRIPTION OF THE PREFERRED EMBODIMENTS

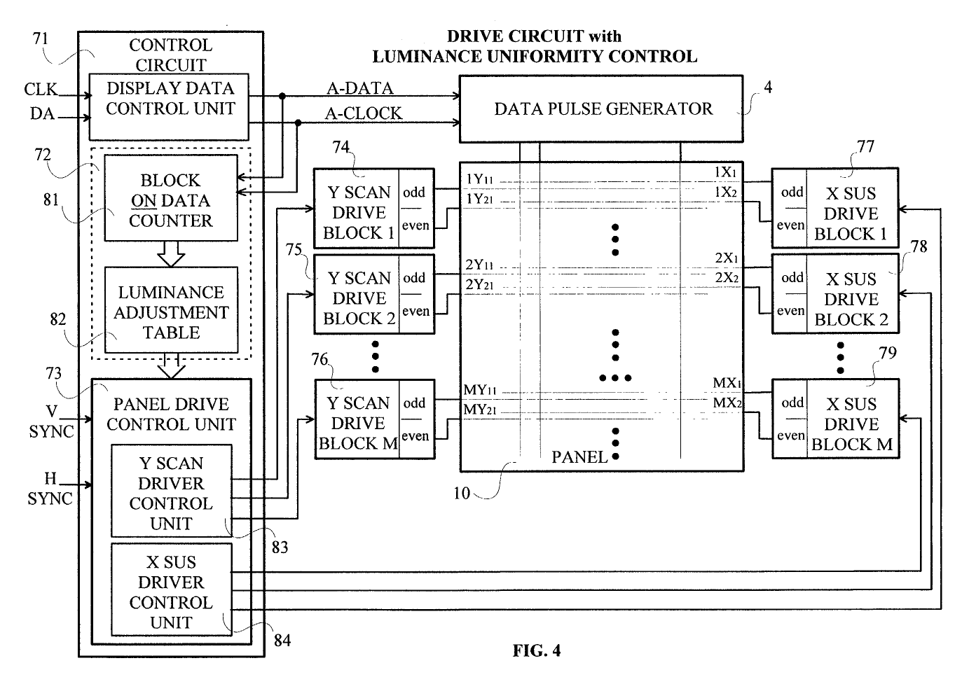

The following is an explanation of the embodiments of the invention with reference to the drawings. The first embodiment is the method for obtaining luminance uniformity across the entire plasma display screen when independently controlled drive block circuits are used to generate the sustain pulses. FIG. 4 is a drawing of the display drive circuit for the PDP. New to the control circuit “71” is the additional circuitry, shown in the dotted area “72”, of a block on data counter “81” and a luminance adjustment table “82”. The output from the luminance adjustment table causes the panel drive control unit “73” to change the number of sustain pulses generated by each drive block “74”˜“79”. This is used to compensate for the differences in luminance that would have resulted from large variation in loading to the block drive circuit “74”˜“79” by its plasma display screen segment “10”.

The block on data counter “81” accumulates the total number of on cells for the display screen segment driven by each drive block circuit “74”˜“79”. Counting the number of on cells is done during the addressing period for each block and is equal to the total number of cells on in that plasma display screen segment for that block. The counter output addresses the luminance adjustment table “82”. This is a lookup table that has been programmed to adjust the number of sustain pulses that are generated by each drive block “74”˜“79”. The number of sustain pulses is based upon the brightness level, the subfield and an adjustment that is made to the total number of sustain pulses to compensate for the different loading of the plasma display screen segment to its drive block electronics. This additional control of the number of sustain pulses makes possible luminance uniformity across the entire plasma display screen.

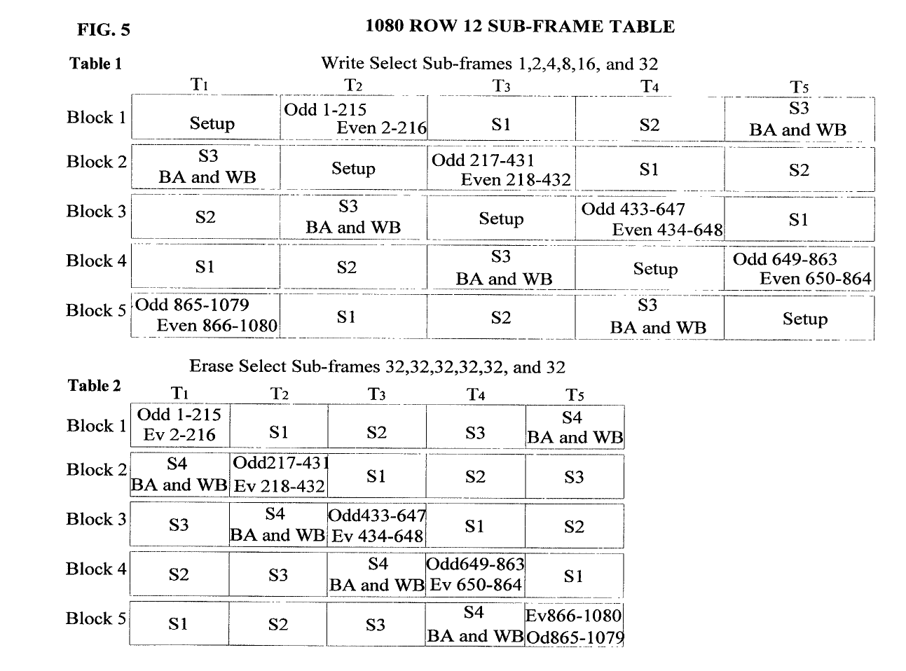

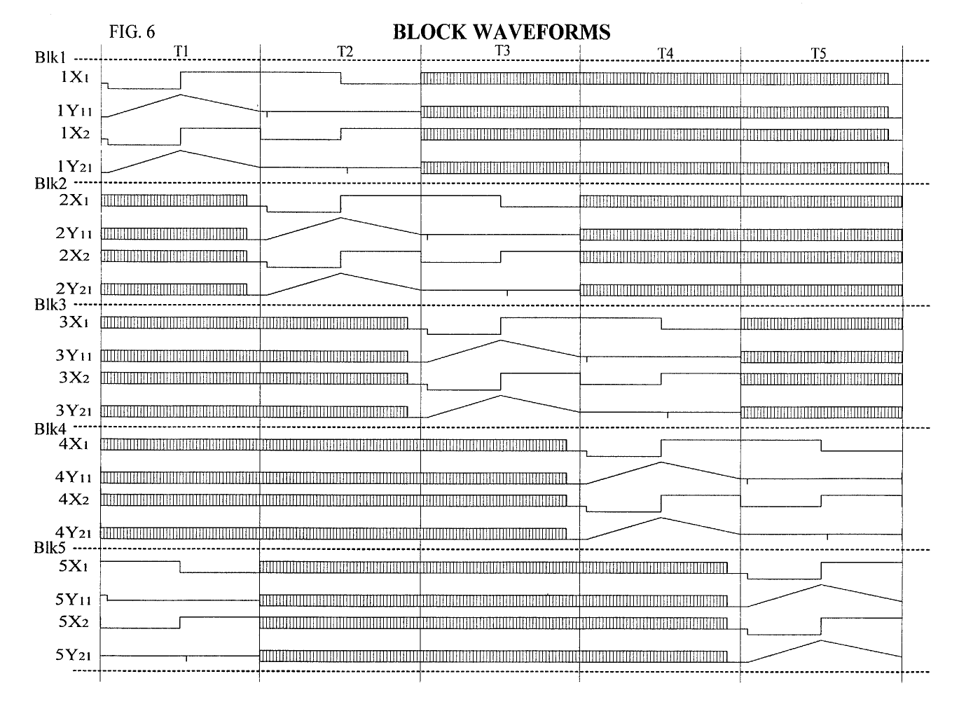

FIGS. 5 and 6 further illustrate the need for a method of controlling luminance uniformity of a block driven plasma display screen. The illustration used is a 1080 row display divided into five segments. Each segment has its own separately controlled drive electronics “71”˜“79”. Therefore, as the number of on cells varies in a segment of the display panel, brightness can be affected by a change in voltage drop across the drive electronics “74”˜“79”. FIG. 5 illustrates the timing relationship of the five blocks. FIG. 5 is a table that illustrates the timing relationships for a 1080 row plasma display panel that is divided into five drive blocks and has twelve sub-frames used to create 256 gray scale levels. Six of the sub-frames are selective write addressing (table 1 of FIG. 5) while the remaining six sub-frames use selective erase addressing (table 2 of FIG. 5). FIG. 6 illustrates the waveforms for Table 1 of FIG. 5. The new gray scale method of combination of sub-frames (FIG. 5 table 1) and accumulation of sub-frames (FIG. 5 table 2) is used. Waveforms of each block, as “2” shown in FIG. 6, illustrate why independently controlled drive block electronics “74”˜“79” are needed for each plasma display screen segment. By being able to electronically control the brightness of each plasma display screen segment the luminance uniformity of the entire plasma display screen is maintained. Each block of FIGS. 5 and 6 has five time periods. Using Block 1 of Table 1 as an example, time T₁ is a setup period in which a ramp up and down waveform conditions the plasma display screen cells, establishing wall charge that is just below the firing voltage for each cell. Time T₂ is an address period in which cells in the odd and even rows of the display are turned on if they are to have light emissions. Time T₃ and T₄ are sustaining periods where sustain pulses generated by the drive blocks are applied to the plasma display screen segment. Time T₅ is a continuation of sustain pulses, plus a brightness adjustment needed to correct for changes in cell loading. Also, an adjustment of the number of sustain pulses of each color performs a white balance of the plasma display panel. The number of sustain pulses for brightness adjustment is determined by three things. One, the present subfield who's sustain pulse numbers are weighted to the gray scale level. Two, brightness level, which increases or decreases the number of sustain pulses of the weighted gray scale levels. Three; related to the present invention, which is an adjustment to the number of sustain pulses as determined by the plasma display screen segment loading of its drive block electronics “74”˜“79”.

While the invention has been described as having specific embodiments, it will be understood that it is capable of further modification. This application is, therefore, intended to cover any variations, uses or adaptations of the invention following the general principles thereof and including such departures from the present disclosure as come within known or customary practice in the art to which this invention pertains and fall within the limits of the appended claims.

What is claimed is:

1. A method of driving a plasma display panel having a plurality of independently driven display drive blocks of cells wherein each image is displayed on the panel by addressing on desired cells in each drive block and sustaining the on cells with a desired number of sustain pulses, said method comprising:
determining the number of on cells of each display drive block; and,
adjusting the desired number of sustain pulses of each display drive block, whereby the luminance of each drive block is adjusted.

2. The method of driving a plasma display panel of claim 1 wherein said step of determining the number of on cells occurs for each drive block during the addressing of the drive block.

3. The method of driving a plasma display panel of claim 1 further comprising the step of establishing the sustain pulse adjustment for each drive block by using a luminance adjustment table.

4. The method of driving a plasma display panel of claim 1 wherein said adjustment for each drive block is determined by the number of on cells in the drive block.

5. The method of driving a plasma display panel of claim 1 further comprising the step of establishing the sustain pulse adjustment for each drive block using a luminance adjustment table, and wherein said adjustment for each drive block is determined by the number of on cells in the drive block, whereby luminance uniformity is maintained between drive blocks on the plasma display panel.

6. The method of driving a plasma display panel of claim 5 wherein said step of determining the number of on cells occurs for each drive block during the addressing of the drive block.

7. The method of driving a plasma display panel of claim 6 wherein, during said step of adjusting, the number of sustain pulses is increased as the number of on cells increases.

8. The method of driving a plasma display panel of claim 4 wherein, during said step of adjusting, the number of sustain pulses is increased as the number of on cells increases.

9. The method of driving a plasma display panel of claim 1 wherein, during said step of adjusting, the number of sustain pulses is increased as the number of on cells increases.
